(19) United States
(12) Patent Application Publication
(10) Pub. No.: US 2013/0135853 A1
(43) Pub. Date: May 30, 2013

(54) LIGHT-GUIDING ELEMENT, LIGHT-EMITTING DIODE LAMP TUBE AND ILLUMINATION LAMP

(71) Applicants: Chi-Feng Lin, Tainan City (TW); Yu-Bin Fang, Tainan City (TW); Chia-Chin Chen, Tainan City (TW)

(72) Inventors: Chi-Feng Lin, Tainan City (TW); Yu-Bin Fang, Tainan City (TW); Chia-Chin Chen, Tainan City (TW)

(21) Appl. No.: 13/306,756

(22) Filed: Nov. 29, 2011

(51) Int. Cl. F21V 8/00; G02B 6/26

(52) U.S. Cl. 362/223; 385/39

(57) ABSTRACT

The present invention is related to a light-guiding element, a light-emitting diode (LED) lamp tube and an illumination lamp. The present invention utilizes a light-guiding element disposed on a light-emitting unit of the LED lamp tube. The light-guiding element includes a first surface and a second surface. The first surface is spaced with a plurality of reflecting units in a longitudinal direction thereof, and the second surface is partitioned with a reflecting area and non-reflecting areas corresponding to the reflecting units of the first surface. The light-emitting unit includes LEDs correspondingly attached to the non-reflecting areas of the second surface of the light-guiding element. An elongated light-emitting surface can be uniformly generated from the LED lamp tube by utilizing a destroyed total reflection phenomenon caused by lights in between the reflecting units of the first surface and the reflecting area of the second surface.

### BACKGROUND OF THE INVENTION

1. Field of the Invention

The present invention relates to a light-guiding element, a light-emitting diode lamp tube and an illumination lamp, and in particular relates to a structure providing a light-guiding element disposed on a light-emitting unit of a light-emitting diode lamp tube and enabling the light-emitting diode lamp tube to form a uniform and elongated light emitting surface.

2. Description of the Related Art

With the various advantages of light-emitting diodes (LEDs), such as high luminous brightness, long life span, energy conservation and environmental protection, most of countries in the world are devoted to popularize the application of the LEDs. However, the LEDs still cannot be popularized because the manufacturing cost thereof is higher than that of the conventional fluorescent light.

Referring to FIG. 13, a conventional LED lamp tube includes a printed circuit board (PCB) ‘A’ assembled with a series of twenty LEDs ‘B’, wherein a spacing ‘H’ of 24 mm is formed between two adjacent LEDs ‘B’. Referring to FIG. 14, a conventional LED lamp tube includes a printed circuit board (PCB) ‘A’ assembled with a series of twenty LEDs ‘B’, wherein a spacing ‘H1’ of 10 mm is formed between two adjacent LEDs ‘B’.

Referring to FIGS. 15 and 16, two luminance diagrams of the two conventional LED lamp tubes in FIGS. 13 and 14 are illustrated, respectively. It can be found that, after the optical simulation to the two conventional LED lamp tubes in FIGS. 13 and 14, the conventional LED lamp tube using twenty LEDs ‘B’ provides a light emitting surface having alternatively dark and bright strips thereon, but the conventional LED lamp tube using fifty-one LEDs ‘B’ provides a uniform emitting surface without strips thereon. That is, due to the LED providing high direction performance, only using large amount of the intensely-arranged LEDs ‘B’ can provide the uniform emitting surface. However, the high cost of the LED lamp tube using large amount of LEDs therein still defers the popularization of the LEDs.

Furthermore, it can be observed, from the luminance diagram in FIG. 16, that a uniform emitting surface can be obtained by using a large amount of intensely-arranged LEDs of the LED lamp tube, but there still has dark zones presented on both relative ends of the LED lamp tube. The occurrence of the dark zone is also the disadvantage to be solved for the present LED lamp tubes.

### BRIEF SUMMARY OF THE INVENTION

In view of this, the present invention, incorporated with a light-guiding element, is utilized to eliminate the dark/bright strips and dark zones at two ends of the LED lamp tube and to obtain a uniform emitting surface without dark/bright zones thereon by a reduced amount of the LEDs.

According to a first aspect of the present invention, there is provided a light-guiding element. The light-guiding element is in a transparent and flat elongated shape, and comprises a first surface and a second surface corresponding to the first surface, wherein the first surface is provided with a plurality of reflecting units spaced in a longitudinal direction of the first surface, and the second surface is partitioned with a reflecting area and a plurality of non-reflecting areas sequentially corresponding to the reflecting units of the first surface.

According to a second aspect of the present invention, there is provided a light-emitting diode (LED) lamp tube. The LED lamp tube comprises a light-guiding element, a light-emitting unit and a diffusive lamp shade. The light-guiding element in a transparent and flat elongated shape comprises a first surface and a second surface corresponding to the first surface, wherein the first surface is provided with a plurality of reflecting units spaced in a longitudinal direction of the first surface, and the second surface is partitioned with a reflecting area and a plurality of non-reflecting areas sequentially corresponding to the reflecting units of the first surface. The light-emitting unit comprises an elongated printed circuit board disposed on the second surface of the light-guiding element and a plurality of light-emitting diodes (LEDs) spaced on the elongated printed circuit board such that the LEDs are sequentially and correspondingly attached to the non-reflecting areas of the second surface of the light-guiding element. The diffusive lamp shade is covered on the first surface of the light-guiding element.

According to a third aspect of the present invention, there is provided an illumination lamp. The illumination lamp comprises a LED lamp tube and a lamp seat. The LED lamp tube is electrically connected to and disposed on the lamp seat to form the illumination lamp.

Further, the reflecting units disposed on the light-guiding element are conical holes concaved from the first surface toward the second surface of the light-guiding element.

Further, the reflecting units are V-shaped slots concaved from the first surface toward the second surface of the light-guiding element.

Further, the reflecting area of the second surface of the light-guiding element is deployed with a plurality of reflecting net dots.

Further, the reflecting area of the second surface of the light-guiding element has a surface property providing a reflection property, and the first surface of the light-guiding element further comprises an area having a rough surface except the reflecting units disposed thereon.

Further, the reflecting units are equally spaced on first surface of the light-guiding element.

Further, the LED lamp tube comprises two power connectors disposed on two ends of the elongated printed circuit board of the light-emitting unit to fixedly connect the elongated printed circuit board of the light-emitting unit and the diffusive lamp shade. The two power connectors are electrically connected to the elongated printed circuit board of the light-emitting unit. The lamp seat comprises two power plugging ends for connection of the two power connectors.

The present invention provides the functions and effects as follows.

The light transmitted between the reflecting units the first surface of the light-guiding element and the reflecting area of the second surface of the light-guiding element has a destroyed total reflection phenomenon, capable of forming a uniform light-emitting surface. Further, the LED lamp tube of the present invention can utilize a reduced amount of the LEDs to form a uniform light-emitting surface, capable of reducing the amount of the required LEDs and the cost of the LED lamp tube and popularizing the application of the energy-conserved LED illuminations.

A detailed description is given in the following embodiments with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention can be more fully understood by reading the subsequent detailed description and examples with references made to the accompanying drawings, wherein:

FIG. 1 is a perspective outside view of a light-guiding element of the present invention;

FIG. 2 is a sectional view of a light-guiding element of the present invention;

FIG. 3 is distribution diagram showing reflecting net dots deployed on a light-guiding element of the present invention;

FIG. 4 is a schematic view of another type of reflecting units disposed on a light-guiding element of the present invention;

FIG. 5 is a perspective exploded view of a light-emitting diode lamp tube of the present invention;

FIG. 6 is a perspective assembled view of a light-emitting diode lamp tube of the present invention;

FIG. 7 is a partial sectional view of a light-emitting diode lamp tube of the present invention;

FIG. 8 is an luminance diagram of a light-emitting diode lamp tube of the present invention;

FIG. 9 is a curve diagram of position and luminous brightness of a light-emitting diode lamp tube of the present invention and a conventional light-emitting diode lamp tube;

FIG. 10 is a curve diagram of luminous efficiency and luminous uniformity of a light-emitting diode lamp tube of the present invention and a conventional light-emitting diode lamp tube;

FIG. 11 is a plan schematic view of an illumination lamp of the present invention;

FIG. 12 is a schematic view of another type of a light-guiding element of the present invention;

FIG. 13 is a schematic view of a conventional light-emitting diode lamp tube using twenty LEDs;

FIG. 14 is a schematic view of a conventional light-emitting diode lamp tube using fifty-one LEDs;

FIG. 15 is a luminance diagram of a conventional light-emitting diode lamp tube using twenty LEDs; and

FIG. 16 is a luminance diagram of a conventional light-emitting diode lamp tube using fifty-one LEDs.

### DETAILED DESCRIPTION OF THE INVENTION

The following description is the best-contemplated mode of embodiments carrying out the main effects of a light-guiding element, a light-emitting diode (LED) lamp tube and an illumination lamp of the invention.

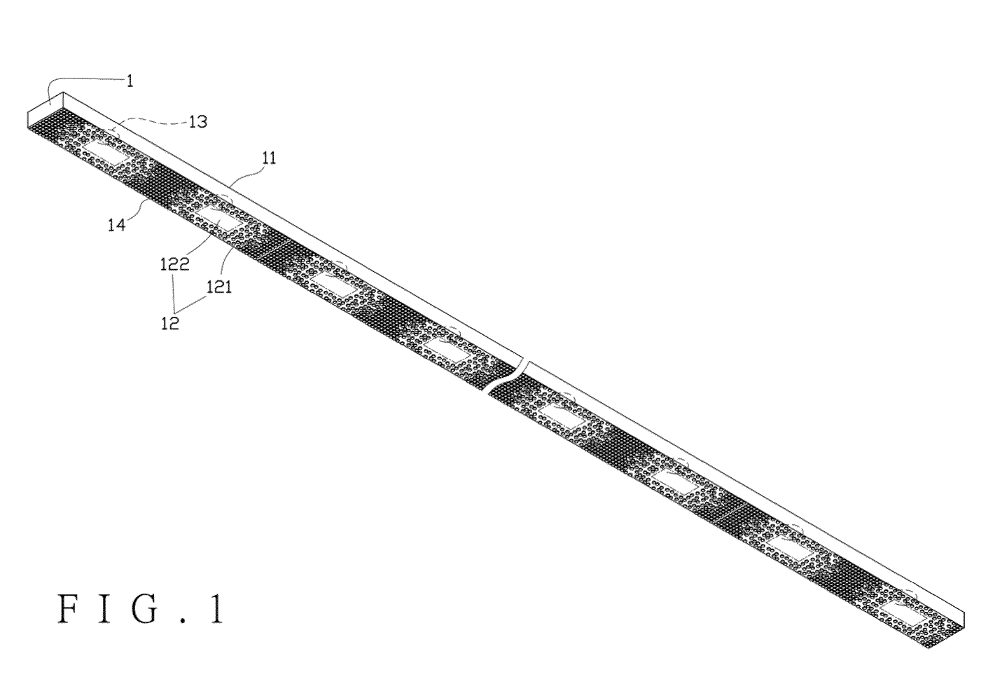

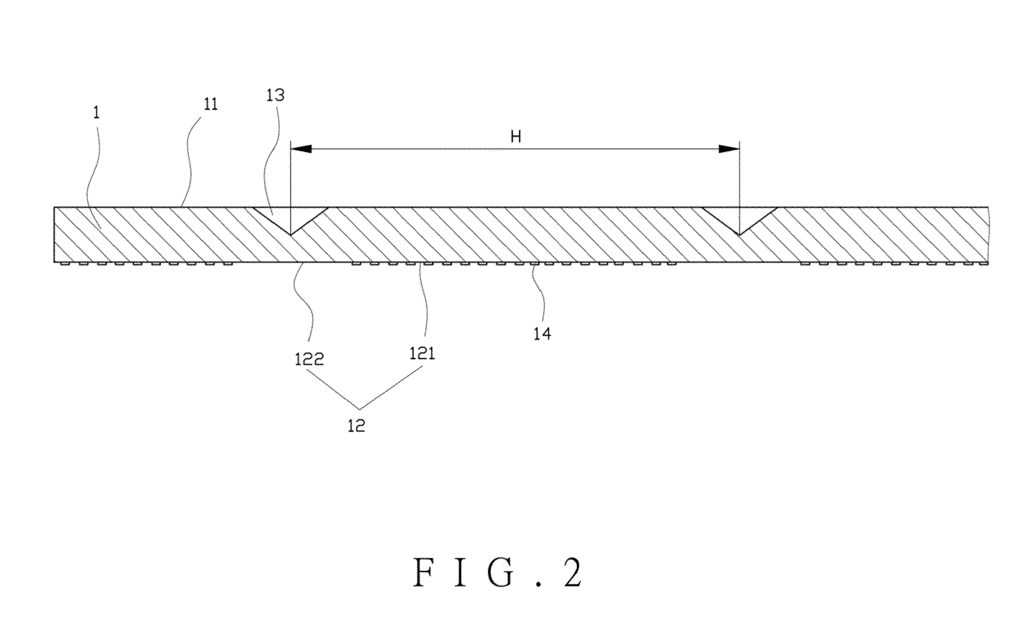

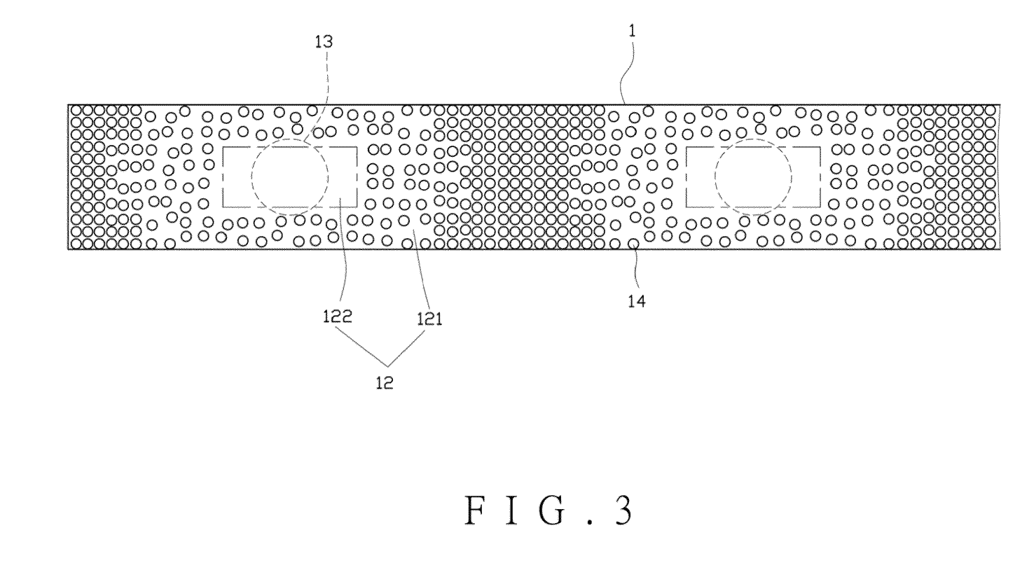

Referring to FIGS. 1, 2 and 3, a light-guiding element 1 of a first embodiment of the invention is formed in a transparent and flat elongated shape, and comprises a first surface 11 and a second surface 12 corresponding to the first surface 11. A series of reflecting units are equally spaced with a spacing ‘H’ of 24 mm on the first surface 11 in a longitudinal direction thereof. In this embodiment, the reflecting units disposed on the light-guiding element 1 are conical holes 13 concaved from the first surface 11 toward the second surface 12 of the light-guiding element 1. A reflecting area 121 and a plurality of non-reflecting areas 122 are partitioned on the second surface 12 of the light-guiding element 1, wherein the non-reflecting areas 122 are located corresponding to the conical holes 13 disposed on the first surface 11, and the reflecting area 121 of the second surface 12 is deployed with a plurality of reflecting net dots 14 (shown in FIG. 3).

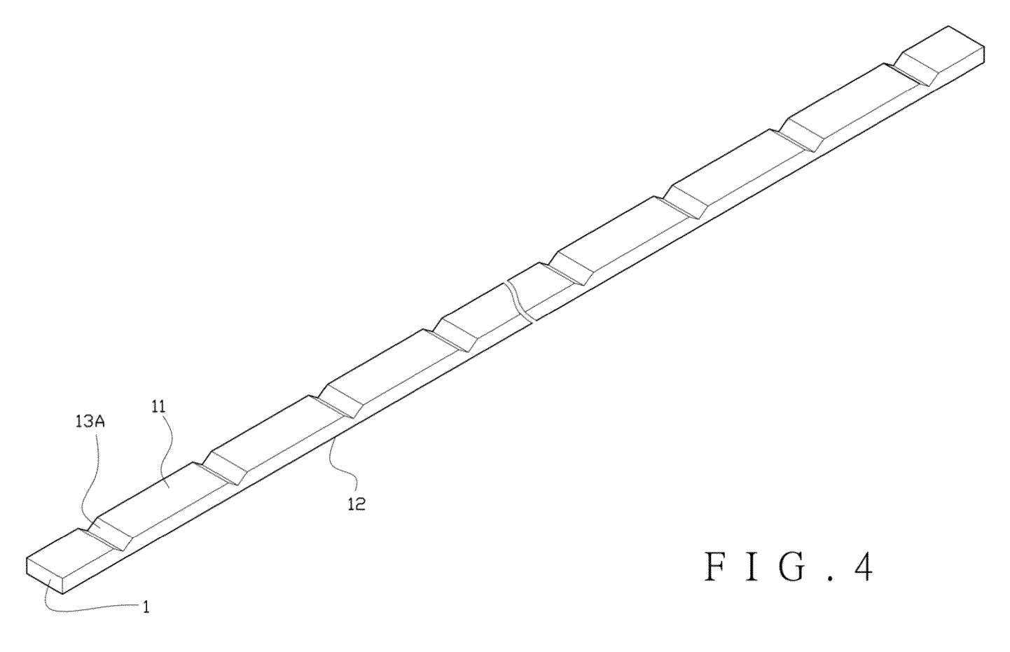

Referring to FIG. 4, another type of reflecting units disposed on a light-guiding element 1 of the present invention is illustrated. The reflecting units are V-shaped slots 13A concaved from the first surface 11 toward the second surface 12 of the light-guiding element 1.

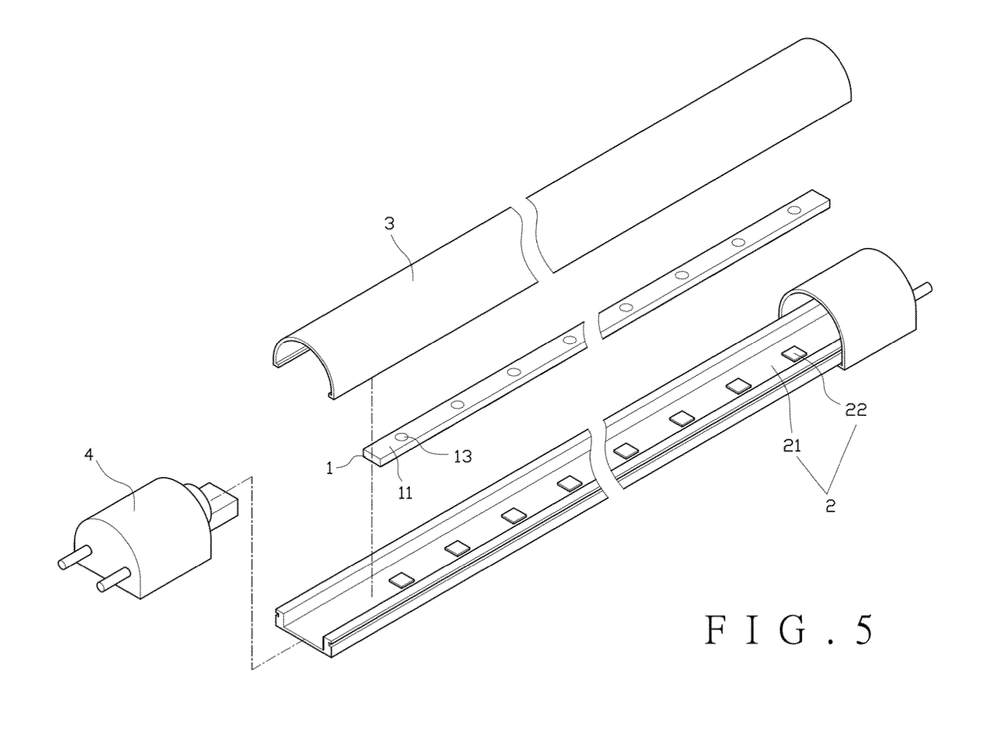

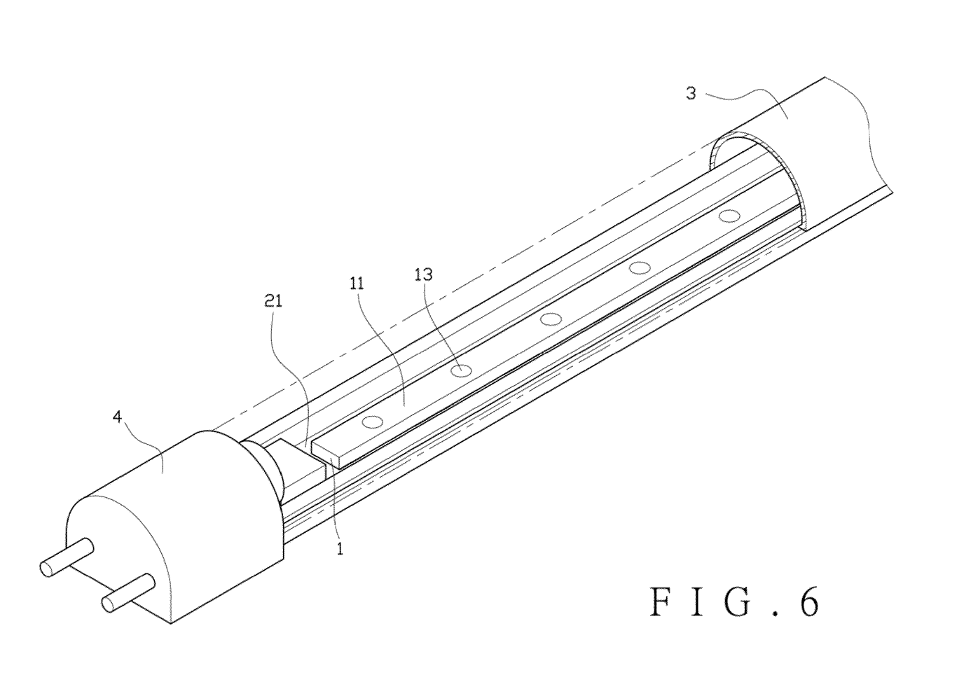

Referring to FIGS. 5 and 6, the LED lamp tube further comprises a light-emitting unit 2, a diffusive lamp shade 3 and two power connectors 4.

The light-emitting unit 2 comprises an elongated printed circuit board (PCB) 21 disposed on the second surface 12 of the light-guiding element 1 and a plurality of LEDs 22 spaced on the elongated PCB 21 such that the LEDs are sequentially and correspondingly attached to the non-reflecting areas 122 of the second surface 12 of the light-guiding element 1. The diffusive lamp shade 3 covers the first surface 11 of the light-guiding element 1. The two power connectors 4, electrically connected to the elongated PCB 21 of the light-emitting unit 2, are disposed on two ends of the elongated PCB 21 of the light-emitting unit 2 to fixedly connect the elongated PCB 21 of the light-emitting unit 2 and the diffusive lamp shade 3.

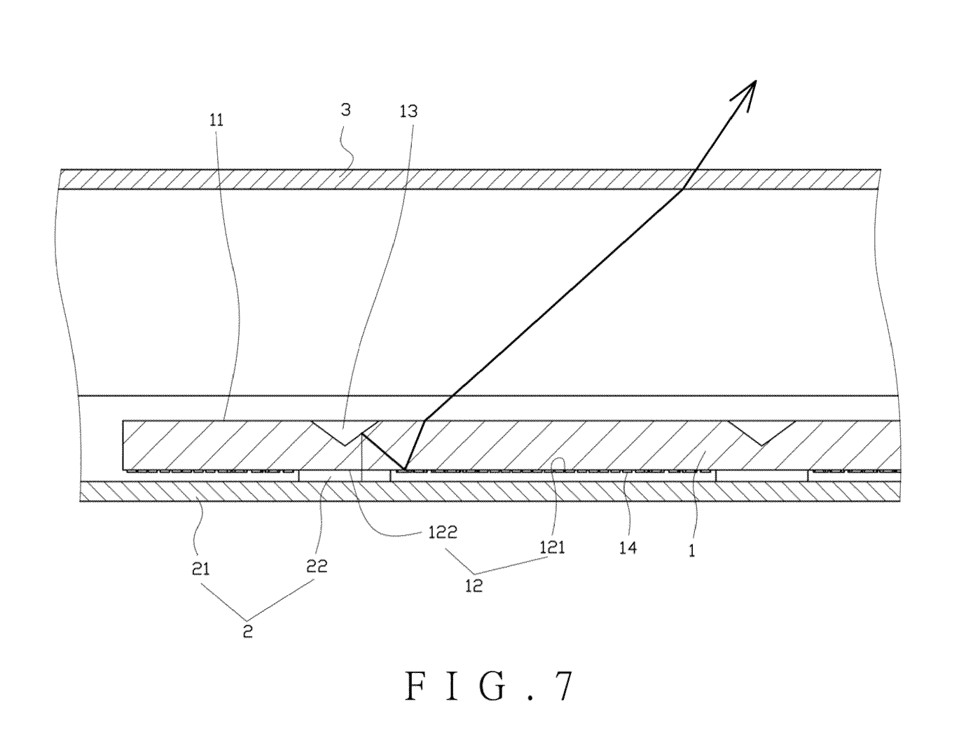

Referring to FIG. 7, when the light emitted from the LEDs 22 is incident in the light-guiding element 1, the light is guided back to and transmitted in the inside of the light-guiding element 1 by the conical holes 13 or the V-shaped slots 13A (shown in FIG. 4) thereon, such that the normal incident light from the LEDs 22 to be directly transmitted through the light-guiding element 1 and scattered by the diffusive lamp shade 3 to the environment with non-uniform brightness can be prevented. The light transmitted inside the light-guiding element 1 has a destroyed total reflection phenomenon while projecting on the reflecting net dots 14 of the light-guiding element 1, and then the light is directed toward and outwardly scattered by the first surface 11 of the light-guiding element 1, such that a uniform light-emitting surface can be formed when the light is outwardly scattered by the diffusive lamp shade 3.

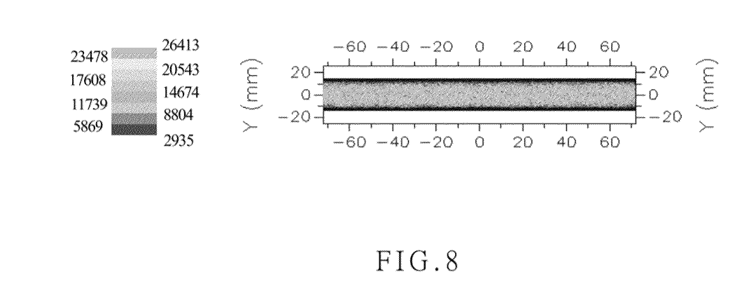

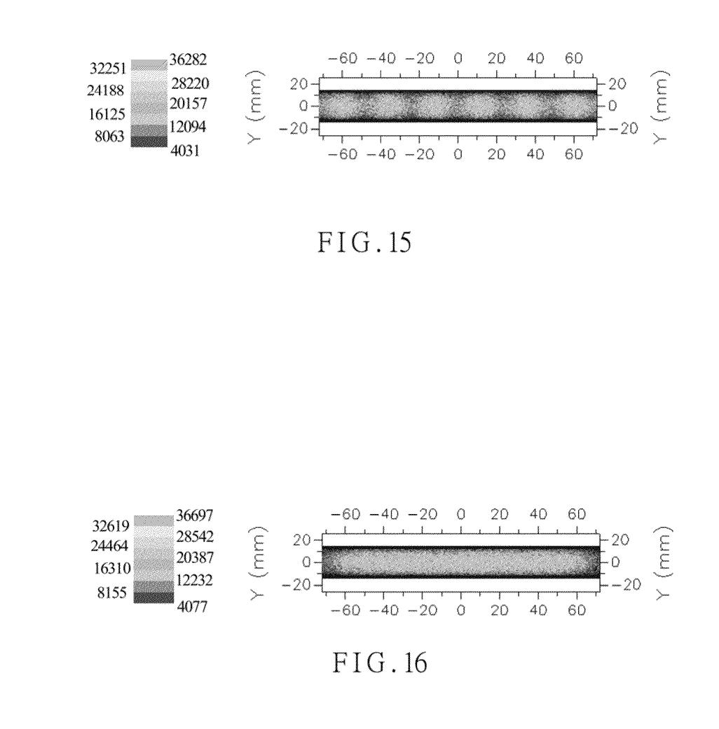

Referring to FIG. 8, when the optical simulation of the LED lamp tube is completed, it is understood that the LED lamp tube of the present invention has an excellent luminous uniformity, compared to the conventional LED lamp tube without using the light-guiding element 1 shown in FIGS. 15 and 16.

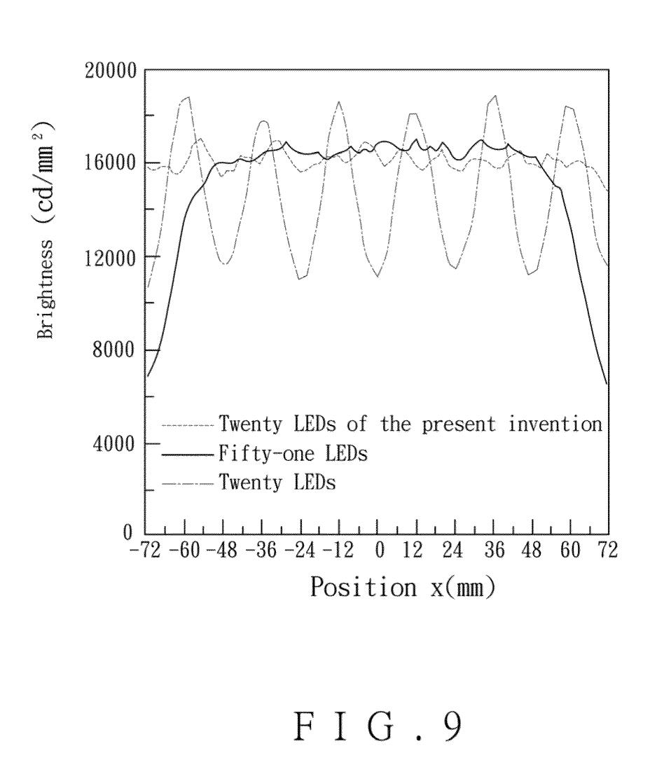

Referring to FIG. 9, a curve diagram of the luminous brightness of the conventional LED lamp tube without using the light-guiding element 1 and the LED lamp tube of the present invention is illustrated. According to the curves in FIG. 9, it can be seen that the LED lamp tube of the present invention has a uniform luminous brightness at each position thereof, but the conventional LED lamp tube without using the light-guiding element 1 has a luminous brightness of large-ranged vertical vibration and particular fast-descending luminous brightness at both curve ends thereof.

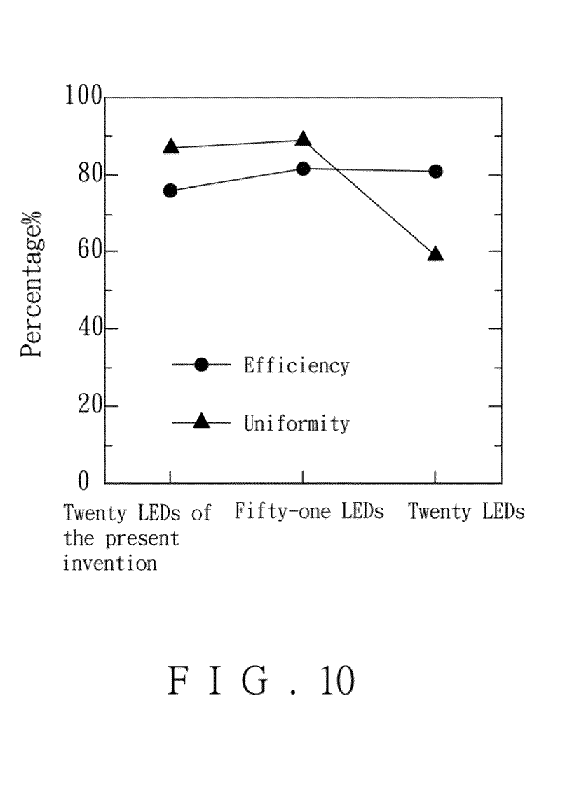

Referring to FIG. 10, a curve diagram of luminous efficiency and luminous uniformity of the conventional LED lamp tube without using the light-guiding element 1 and the LED lamp tube of the present invention is illustrated. In FIG. 10, it can be seen that the luminous uniformity of the LED lamp tube of the present invention using twenty LEDs is quite similar to that of the conventional LED lamp tube using fifty-one LEDs, but the LED lamp tube of the present invention uses more than half of the LED amount compared to the conventional LED lamp tube. Further, in FIG. 10, the LED lamp tube of the present invention can have a high luminous efficiency (76%), slightly less than that of the conventional LED lamp tube without using the light-guiding element 1. Thus, it is proved that, with the high luminous efficiency and excellent luminous uniformity of the LED lamp tube of the present invention, the cost of the LED product can be reduced.

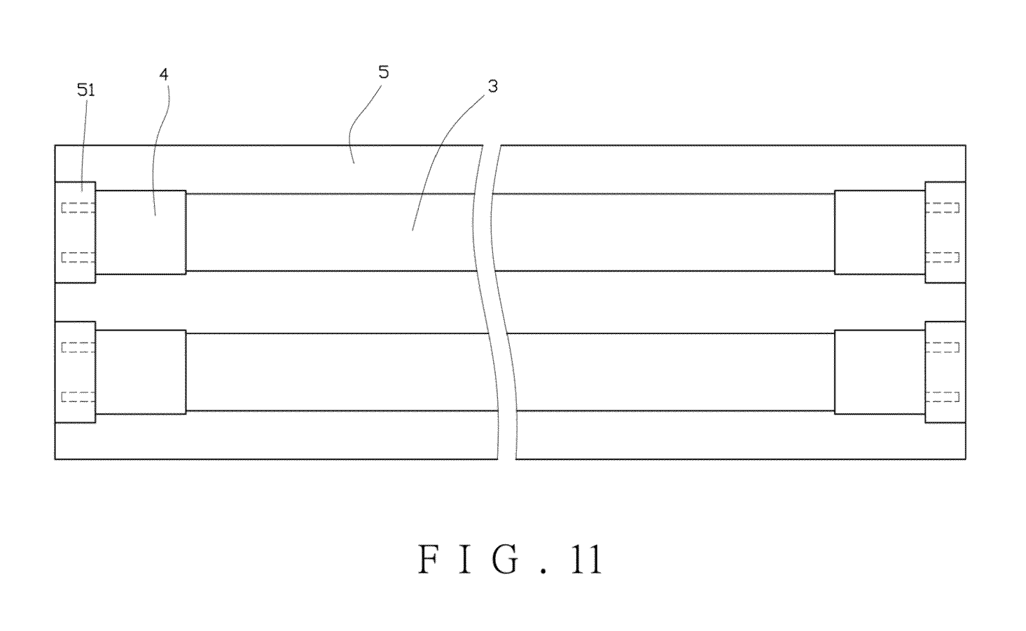

Referring to FIG. 11, the illumination lamp further comprises a lamp seat 5, and the LED lamp tube is electrically connected to and disposed on the lamp seat 5. The lamp seat 5 includes two power plugging ends 51 for connection of the two power connectors 4. With the two power connectors 4 connected to the lamp seat 5, the assembly of the illumination lamp of the present invention is completed.

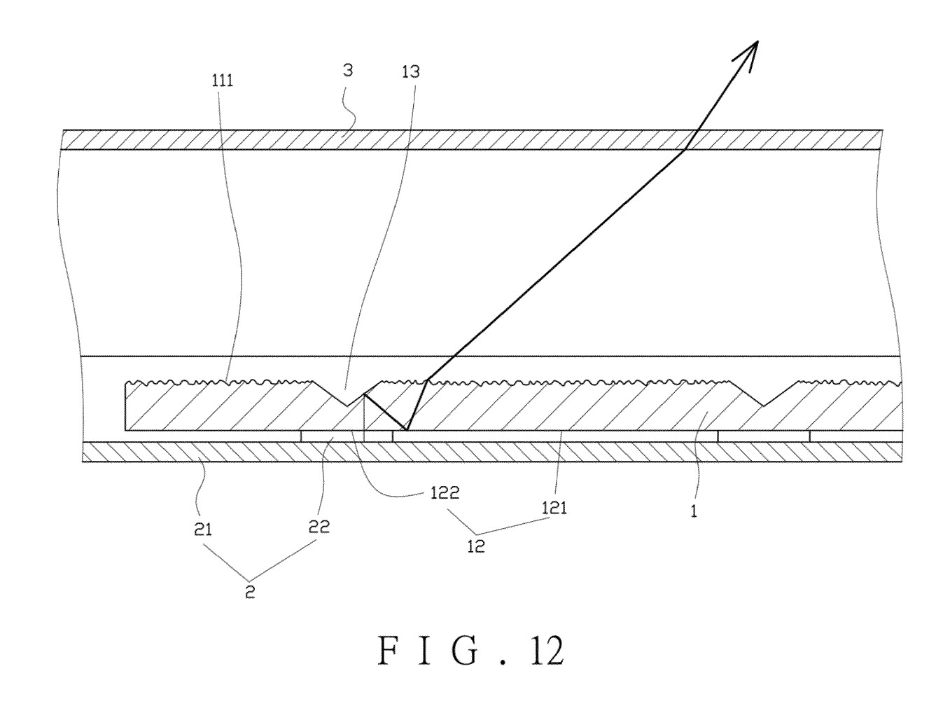

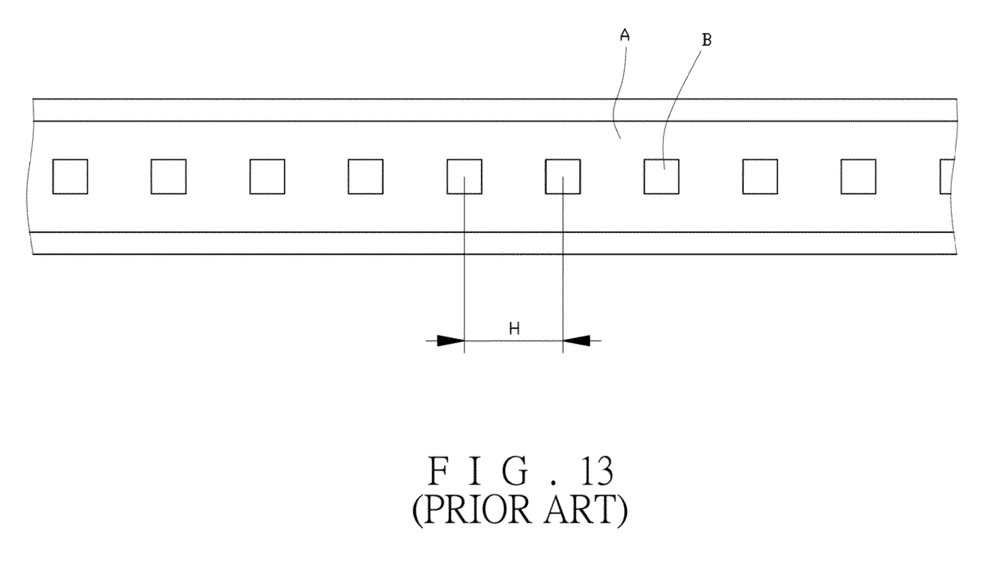

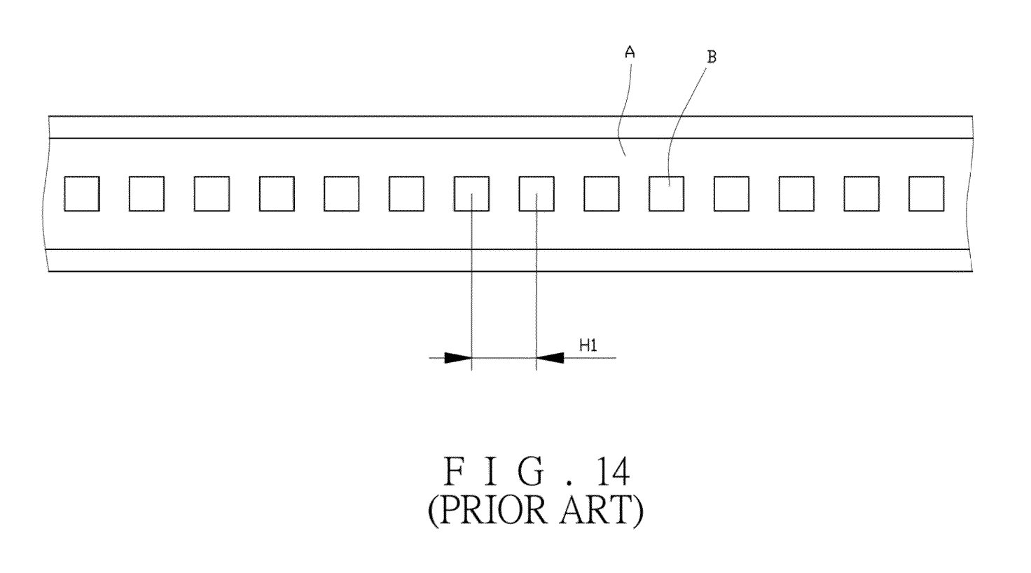

Referring to FIG. 12, another type of a light-guiding element of a second embodiment of the present invention is illustrated. The reflecting area 121 of the second surface 12 of the light-guiding element 1 has a surface property providing a reflection property, and the first surface 11 of the light-guiding element 1 further comprises an area having a rough surface 111 except the reflecting units (the conical holes 13 or V-shaped slots 13A) disposed thereon. The light transmitted inside the light-guiding element 1 can have a destroyed total reflection phenomenon while projecting on the rough surface 111 of the light-guiding element 1, such that a uniform light-emitting surface can be formed when the light is outwardly scattered by the diffusive lamp shade 3.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light-guiding element in a transparent and flat elongated shape, comprising a first surface and a second surface corresponding to the first surface, the first surface being provided with a plurality of reflecting units spaced in a longitudinal direction of the first surface, and the second surface being partitioned with a reflecting area and a plurality of non-reflecting areas sequentially corresponding to the reflecting units of the first surface.

2. The light-guiding element as claimed in claim 1, wherein the reflecting units are conical holes concaved toward the second surface.

3. The light-guiding element as claimed in claim 1, wherein the reflecting units are V-shaped slots concaved toward the second surface.

4. The light-guiding element as claimed in claim 1, wherein the reflecting area of the second surface is deployed with a plurality of reflecting net dots.

5. The light-guiding element as claimed in claim 1, wherein the reflecting area of the second surface has a surface property providing a reflection property, and the first surface further comprises an area having a rough surface except the reflecting units disposed thereon.

6. The light-guiding element as claimed in claim 1, wherein the reflecting units are equally spaced on first surface.

7. A light-emitting diode lamp tube, comprising:
a light-guiding element in a transparent and flat elongated shape, comprising a first surface and a second surface corresponding to the first surface, the first surface being provided with a plurality of reflecting units spaced in a longitudinal direction of the first surface, and the second surface being partitioned with a reflecting area and a plurality of non-reflecting areas sequentially corresponding to the reflecting units of the first surface;
a light-emitting unit, comprising an elongated printed circuit board disposed on the second surface of the light-guiding element and a plurality of light-emitting diodes spaced on the elongated printed circuit board such that the light-emitting diodes are sequentially and correspondingly attached to the non-reflecting areas of the second surface of the light-guiding element; and
a diffusive lamp shade covering the first surface of the light-guiding element.

8. The light-emitting diode lamp tube as claimed in claim 7, wherein the reflecting units disposed on the light-guiding element are conical holes concaved from the first surface toward the second surface of the light-guiding element.

9. The light-emitting diode lamp tube as claimed in claim 7, wherein the reflecting units are V-shaped slots concaved from the first surface toward the second surface of the light-guiding element.

10. The light-emitting diode lamp tube as claimed in claim 7, wherein the reflecting area of the second surface of the light-guiding element is deployed with a plurality of reflecting net dots.

11. The light-emitting diode lamp tube as claimed in claim 7, wherein the reflecting area of the second surface of the light-guiding element has a surface property providing a reflection property, and the first surface of the light-guiding element further comprises an area having a rough surface except the reflecting units disposed thereon.

12. The light-emitting diode lamp tube as claimed in claim 7, wherein the reflecting units are equally spaced on first surface of the light-guiding element.

13. The light-emitting diode lamp tube as claimed in claim 7, further comprising two power connectors disposed on two ends of the elongated printed circuit board of the light-emitting unit to fixedly connect the elongated printed circuit board of the light-emitting unit and the diffusive lamp shade, the two power connectors being electrically connected to the elongated printed circuit board of the light-emitting unit.

14. An illumination lamp, comprising:
a light-emitting diode lamp tube, comprising:
a light-guiding element in a transparent and flat elongated shape, comprising a first surface and a second surface corresponding to the first surface, the first surface being provided with a plurality of reflecting units spaced in a longitudinal direction of the first surface, and the second surface being partitioned with a reflecting area and a plurality of non-reflecting areas sequentially corresponding to the reflecting units of the first surface;
a light-emitting unit, comprising an elongated printed circuit board disposed on the second surface of the light-guiding element and a plurality of light-emitting diodes spaced on the elongated printed circuit board such that the light-emitting diodes are sequentially and correspondingly attached to the non-reflecting areas of the second surface of the light-guiding element; and
a diffusive lamp shade covering the first surface of the light-guiding element; and
a lamp seat, the light-emitting diode lamp tube being electrically connected to and disposed on the lamp seat.

15. The illumination lamp as claimed in claim 14, wherein the reflecting units disposed on the light-guiding element are conical holes concaved from the first surface toward the second surface of the light-guiding element.

16. The illumination lamp as claimed in claim 14, wherein the reflecting units are V-shaped slots concaved from the first surface toward the second surface of the light-guiding element.

17. The illumination lamp as claimed in claim 14, wherein the reflecting area of the second surface of the light-guiding element is deployed with a plurality of reflecting net dots.

18. The illumination lamp as claimed in claim 14, wherein the reflecting area of the second surface of the light-guiding element has a surface property providing a reflection property, and the first surface of the light-guiding element further comprises an area having a rough surface except the reflecting units disposed thereon.

19. The illumination lamp as claimed in claim 14, wherein the reflecting units are equally spaced on first surface of the light-guiding element.

20. The illumination lamp as claimed in claim 14, further comprising two power connectors disposed on two ends of the elongated printed circuit board of the light-emitting unit to fixedly connect the elongated printed circuit board of the light-emitting unit and the diffusive lamp shade, the two power connectors being electrically connected to the elongated printed circuit board of the light-emitting unit, the lamp seat comprising two power plugging ends which are provided for connection of the two power connectors.
